(19) United States
(12) Patent Application Publication
(10) Pub. No.: US 2021/0010144 A1
(43) Pub. Date: Jan. 14, 2021

(54) METHOD OF MANUFACTURING MULTIPLE-COLOR PLATING MEMBER AND MULTIPLE-COLOR PLATING MEMBER MANUFACTURED USING THE SAME

(71) Applicants: HYUNDAI MOTOR COMPANY, Seoul (KR); KIA MOTORS CORPORATION, Seoul (KR)

(72) Inventors: Hyun Kyung Kim, Hwaseong-si (KR); Dong Eun Cha, Hwaseong-si (KR); Jin Young Yoon, Gimpo-si (KR); Hai Chang Lee, Ansan-si (KR); Sun Young Park, Siheung-si (KR)

(21) Appl. No.: 16/912,172

(22) Filed: Jun. 25, 2020

(30) Foreign Application Priority Data
Jul. 11, 2019 (KR) 10-2019-0084064

(51) Int. Cl. C25D 3/12; C25D 3/06; C25D 3/38; B05D 5/06; C25D 3/08; C25D 5/14; C25D 5/16; C25D 5/48; C25D 5/00; B05D 7/00

(52) U.S. Cl. CPC C25D 3/12; C25D 3/06; C25D 3/38; B05D 5/06; C25D 3/08; B05D 2502/005; C25D 5/16; C25D 5/48; C25D 5/627; B05D 7/57; C25D 5/14

(57) ABSTRACT

A method of manufacturing a multiple-color plating member includes forming a copper plating layer on at least a part of a surface of a substrate, forming a nickel plating layer on a surface of the copper plating layer, forming a chromium plating layer on a surface of the nickel plating layer, applying a color coating agent onto a surface of the chromium plating layer and then drying the applied color coating agent to form a color coating layer, and applying a clear coating agent onto a surface of the color coating layer and photocuring the applied clear coating agent to form a clear layer. The color coating agent includes 10 to 35% by weight of a modified acrylic resin, 1 to 25% by weight of a pigment, and 40 to 80% by weight of a first solvent. The clear coating agent includes 10 to 30% by weight of a polyester-modified acrylic resin, 5 to 25% by weight of an acrylic oligomer, 5 to 45% by weight of an acrylic monomer, 1 to 15% by weight of a photoinitiator, and 10 to 75% by weight of a second solvent.

### CROSS REFERENCE TO RELATED APPLICATIONS

This application claims, under 35 U.S.C. § 119(a), the benefit of priority to Korean Patent Application No. 10-2019-0084064 filed on Jul. 11, 2019, the entire contents of which are incorporated herein by reference.

### BACKGROUND

### (a) Technical Field

The present disclosure relates to a method of manufacturing a multiple-color plating member and a multiple-color plating member manufactured using the same.

### (b) Background Art

Plastic parts utilized in applications such as construction members and interior and exterior parts for vehicles include a plating layer formed on the surface thereof in order to secure corrosion resistance and wear resistance and improve the appearance thereof. In addition, in recent years, the importance of surface treatment technology for interior and exterior parts for vehicles has increased with the goal of extending the life of vehicle parts or increasing the safety thereof by securing durability from various aspects as well as improving the appearance thereof.

Meanwhile, the exterior parts for vehicles include bumpers, front grilles, body peripheral parts, tire peripheral parts and the like. Most of these exterior parts require lightweight materials for improving fuel efficiency in response to environmental regulations in vehicles in accordance with the development of plastic technology having a high strength comparable to that of metal as well as improved heat resistance and thermal conductivity.

The above information disclosed in this Background section is provided only for enhancement of understanding of the background of the present disclosure, and therefore it may include information that does not form the prior art that is already known in this country to a person of ordinary skill in the art.

### SUMMARY

The present disclosure has been made in an effort to solve the above-described problems associated with the prior art.

It is one object of the present disclosure to provide a method of manufacturing a multiple-color plating member having an excellent appearance and superior chipping resistance and scratch resistance.

It is another object of the present disclosure to provide a method of manufacturing a multiple-color plating member having excellent durability, chemical resistance and weather resistance.

It is another object of the present disclosure to provide a method of manufacturing a multiple-color plating member that is lightweight and exhibits excellent light resistance and adhesion between coating layers.

It is yet another object of the present disclosure to provide a multiple-color plating member manufactured using the method described above.

The objects of the present disclosure are not limited to those described above. The objects of the present disclosure will be clearly understood from the following description and are capable of being implemented by means defined in the claims and combinations thereof.

In one aspect, the present disclosure provides a method of manufacturing a multiple-color plating member. In one embodiment, the method may include forming a copper plating layer on at least a part of a surface of a substrate, forming a nickel plating layer on a surface of the copper plating layer, forming a chromium plating layer on a surface of the nickel plating layer, applying a color coating agent onto a surface of the chromium plating layer and then drying the applied color coating agent to form a color coating layer, and applying a clear coating agent onto a surface of the color coating layer and photocuring the applied clear coating agent to form a clear layer, wherein the color coating agent includes 10 to 35% by weight of a modified acrylic resin, 1 to 25% by weight of a pigment, and 40 to 80% by weight of a first solvent, and wherein the clear coating agent includes 10 to 30% by weight of a polyester-modified acrylic resin, 5 to 25% by weight of an acrylic oligomer, 5 to 45% by weight of an acrylic monomer, 1 to 15% by weight of a photoinitiator, and 10 to 75% by weight of a second solvent.

In an embodiment, the forming of the nickel plating layer may include forming a semi-gloss first nickel plating layer on a surface of the copper plating layer, forming a glossy second nickel plating layer on a surface of the first nickel plating layer, and forming a microporous (MP) nickel plating layer on a surface of the second nickel plating layer.

In one embodiment, the copper plating layer may have a thickness of 5 to 30 μm, the nickel plating layer may have a thickness of 5 to 50 μm, and the chromium plating layer may have a thickness of 5 to 20 μm.

In one embodiment, the color coating layer may be formed by drying the applied color coating agent at 60 to 100° C.

In one embodiment, each of the first solvent and the second solvent may include a fast-drying solvent and a slow-drying solvent at a weight ratio of 1:0.3 to 1:1.5.

In one embodiment, the color coating layer may have a thickness of 10 to 30 μm, and the clear layer may have a thickness of 10 to 50 μm.

In another aspect, the present disclosure provides a multiple-color plating member manufactured using the method of manufacturing a multiple-color plating member. In one embodiment, the multiple-color plating member may include a substrate, a copper plating layer formed on at least a part of a surface of the substrate, a nickel plating layer formed on a surface of the copper plating layer, a chromium plating layer formed on a surface of the nickel plating layer, a color coating layer formed on a surface of the chromium plating layer and a clear layer formed on a surface of the color coating layer, wherein the color coating layer is formed using a color coating agent including 10 to 35% by weight of a modified acrylic resin, 1 to 25% by weight of a pigment and 40 to 80% by weight of a first solvent, and wherein the clear coating layer is formed using a clear coating agent including 10 to 30% by weight of a polyester-modified acrylic resin, 5 to 25% by weight of an acrylic oligomer, 5 to 45% by weight of an acrylic monomer, 1 to 15% by weight of a photoinitiator and 10 to 75% by weight of a second solvent.

In one embodiment, the color coating layer and the clear layer may be formed at a thickness ratio of 1:1.2 to 1:3.

### BRIEF DESCRIPTION OF THE FIGURES

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows a method of manufacturing a multiple-color plating member according to an embodiment of the present disclosure;

FIG. 2 shows a multiple-color plating member according to one embodiment of the present disclosure; and

FIG. 3 is an image showing a multiple-color plating member specimen produced according to an embodiment of the present disclosure.

### DETAILED DESCRIPTION

In the following description of the present disclosure, detailed descriptions of known functions and configurations incorporated herein will be omitted when the same may obscure the subject matter of the present disclosure.

The terms used below are defined in consideration of functions in the present disclosure, and may be changed according to intentions or customs of users or operators, and thus the definitions should be understood based on the contents throughout the specification for describing the present disclosure.

### Method of Forming Multiple-Color Plating Member

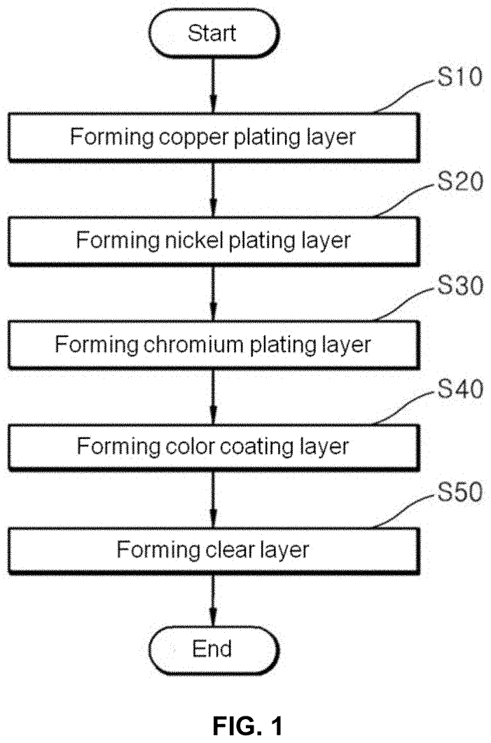

One aspect of the present disclosure relates to a method of manufacturing a multiple-color plating member. FIG. 1 shows a method of manufacturing a multiple-color plating member according to an embodiment of the present disclosure. Referring to FIG. 1, the method of manufacturing a multiple-color plating member includes (S10) forming a copper plating layer, (S20) forming a nickel plating layer, (S30) forming a chromium plating layer, (S40) forming a color coating layer, and (S50) forming a clear layer. More specifically, the method of manufacturing a multiple-color plating member may include (S10) forming a copper plating layer on at least a part of a surface of a substrate, (S20) forming a nickel plating layer on a surface of the copper plating layer, (S30) forming a chromium plating layer on a surface of the nickel plating layer, (S40) applying a color coating agent onto a surface of the chromium plating layer and then drying the applied color coating agent to form a color coating layer, and (S50) applying a clear coating agent onto the surface of the color coating layer and photocuring the applied clear coating agent to form a clear layer.

Hereinafter, the method of manufacturing a multiple-color plating member according to the present disclosure will be described in detail step by step.

### (S10) Forming Copper Plating Layer

In this step, a copper plating layer is formed on at least a part of a surface of a substrate. In one embodiment, the substrate may include polycarbonate (PC), polyvinyl chloride (PVC), polyolefin, polystyrene (PS), polyoxymethylene (POM), ethylene propylene diene monomer (EPDM), polymethyl (meth)acrylate (PMMA), acrylic-styrene-acrylonitrile (ASA), acrylonitrile-butadiene-styrene (ABS) and polyalkylene terephthalate or the like. For example, the substrate may include acrylonitrile butadiene styrene (ABS).

In one embodiment, the surface of the substrate may be pretreated before forming the copper plating layer. In one embodiment, the pretreatment may include degreasing the surface of the substrate; etching the degreased substrate surface and washing the etched substrate surface.

In one embodiment, the degreasing can remove dust and oily substances remaining on the surface of the substrate. In one embodiment, the degreasing may be carried out by immersing the substrate of the substrate in a degreasing solution prepared by mixing water with sodium metasilicate for 1 to 10 minutes. In addition, oily substances such as oil on the surface of the substrate can be removed under various conditions, without being limited to the use of the degreasing solution.

In one embodiment, the etching may be performed to improve adhesion between the surface of the degreased substrate and the plating layer. For example, fine irregularities can be formed on the surface of the substrate by immersing the substrate in an etching solution capable of selectively releasing a rubber component such as butadiene from the substrate containing ABS. The etching solution used herein is not specifically limited, as long as it can form fine irregularities by etching the surface of the substrate of the present disclosure.

In one embodiment, the washing may be carried out to remove the etching solution remaining on the etched substrate surface. In addition, the method may further include neutralizing the remaining etching solution when removal of the etching solution by washing with water is insufficient.

In one embodiment, the method may further include activation of adsorbing a metal catalyst in the fine irregularities formed on the surface of the washed substrate. In one embodiment, by adsorbing palladium (Pd) or the like as a metal catalyst in the fine irregularities of the surface of the substrate, palladium nuclei can be generated and thus adhesion during a subsequent chemical plating process can be further improved.

The copper plating layer can function to improve adhesion between the nickel plating layer and the substrate, and absorb external shocks. In one embodiment, the copper plating layer may be electroplated using a copper plating solution.

The copper plating solution may include, but is not limited to, copper sulfate (CuSO₄.5H₂O), sulfuric acid (H₂SO₄), a chloride ion (Cl⁻), a glossing agent or the like.

In one embodiment, the copper plating layer may have a thickness of 5 to 30 μm. When the copper plating layer is formed to a thickness within the above range, adhesion with the substrate, durability and impact resistance can be excellent.

### (S20) Forming Nickel Plating Layer

In this step, a nickel plating layer is formed on the surface of the copper plating layer.

In one embodiment, forming the nickel plating layer may include forming a semi-gloss first nickel plating layer on a surface of the copper plating layer, forming a glossy second nickel plating layer on a surface of the first nickel plating layer, and forming a microporous (MP) nickel plating layer on the surface of the second nickel plating layer.

The first nickel plating layer may serve to block corrosion of the copper plating layer.

In one embodiment, the first nickel plating layer may be formed by electroplating using a first nickel plating solution. The first nickel plating solution may include nickel sulfate (NiSO₄), nickel chloride (NiCl₂), and boric acid (H₃BO₃), but is not limited thereto.

The second nickel plating layer can provide corrosion resistance as well as glossiness along with the chromium plating layer which will be described later. In one embodiment, the second nickel plating layer may be formed by electroplating using a second nickel plating solution. The second nickel plating solution may include nickel sulfate (NiSO₄), nickel chloride (NiCl₂), and boric acid (H₃BO₃), but is not limited thereto.

In one embodiment, the MP nickel plating layer may be included to function to prevent corrosion of the chromium plating layer, which will be described later, through the formation of micropores.

In one embodiment, the MP nickel plating layer may be formed by electroplating using a MP nickel plating solution. The MP nickel plating solution may include nickel sulfate (NiSO₄), nickel chloride (NiCl₂), and boric acid (H₃BO₃), but is not limited thereto.

In one embodiment, the nickel plating layer may have a total thickness of 5 μm to 50 μm. When the nickel plating layer is formed in the above thickness range, adhesion, durability and impact resistance can be excellent.

### (S30) Forming Chromium Plating Layer

In this step, a chromium plating layer is formed on the surface of the nickel plating layer. The chromium plating layer is formed to impart glossiness and thereby to improve appearance and to secure discoloration resistance, corrosion resistance and wear resistance.

In one embodiment, the chromium plating layer may be formed by electroplating using a chromium plating solution containing a trivalent chromium source (Cr³⁺) or a hexavalent chromium source (Cr⁶⁺).

In one embodiment, the trivalent chromium source includes at least one of chromium sulfate (Cr₂(SO₄)₃), chromium chloride (CrCl₃), chromium nitrate (Cr (HNO₃)₃), and chromium acetate (Cr₂(OAc)₄2H₂O). In addition, the hexavalent chromium source may include one or more of chromic anhydride (CrO₃), sodium dichromate (Na₂CrO₇), potassium dichromate (K₂Cr₂O₇), sodium chromate (Na₂CrO₄) and potassium chromate (K₂CrO₄).

For example, the chromium plating solution may include a trivalent or hexavalent chromium source and a sulfate ion source, but is not limited thereto.

In one embodiment, the chromium plating layer may have a thickness of 5 to 20 μm. Durability, abrasion resistance and appearance of the chromium plating layer can be excellent within the above thickness range.

### (S40) Forming Color Coating Layer

In this step, a color coating agent is applied and dried on the surface of the chromium plating layer to form a color coating layer. In one embodiment, the color coating agent contains 10 to 35% by weight of a modified acrylic resin, 1 to 25% by weight of a pigment and 40 to 80% by weight of a first solvent.

Hereinafter, the ingredients of the color coating layer will be described in more detail.

(1) Modified acrylic resin: In one embodiment, the modified acrylic resin may have a weight average molecular weight of 5,000 to 50,000 g/mol. Under the above conditions, it is easy to adjust the viscosity, and thus workability when forming the color coating layer, the hardness of the coating film, adhesion and scratch resistance can be excellent.

In one embodiment, the modified acrylic resin is present in an amount of 10 to 35% by weight based on the total weight of the color coating agent. When the modified acrylic resin is present in less than 10% by weight, the durability of the color coating layer is lowered, and when the modified acrylic resin is present in an amount exceeding 35% by weight, miscibility, workability and dispersibility may be deteriorated.

(2) Pigment: The pigment is included to impart color to the color coating layer. In one embodiment, the pigment may include components known in the art without limitation. For example, the pigment may include a known pigment such as red pigment, green pigment, blue pigment, yellow pigment, violet pigment or the like. Other examples thereof include known pigments such as silica, carbon black, iron oxide, titanium oxide (TiO₂), antimony (Sb), quinacridone, copper-phthalocyanine and chromium (Cr).

In one embodiment, the pigment is present in an amount of 1 to 25% by weight based on the total weight of the color coating agent. When the pigment is present in an amount less than 1% by weight, aesthetics are deteriorated due to the insignificant coloring effect, and when the pigment is present in an amount exceeding 25% by weight, the dispersibility and miscibility of the color coating agent and the interlayer adhesion and mechanical properties of the color coating layer may be deteriorated.

(3) First solvent: The first solvent makes it easy to adjust the viscosity of the color coating agent and improves the smoothness of the coating layer and workability during coating.

In one embodiment, the first solvent may include at least one of a fast-drying solvent and a slow-drying solvent.

In one embodiment, the fast-drying solvent may be a solvent having an evaporation rate, measured according to ASTM D 3539, higher than 0.8. In one embodiment, the fast-drying solvent may include: a hydrocarbon-based solvent such as n-hexane, n-octane, isooctane or cyclohexane; an aromatic hydrocarbon solvent such as toluene, xylene or mesitylene; an alcohol solvent such as methanol, ethanol, n-propyl alcohol or isopropyl alcohol; an ether solvent such as diethyl ether, dipropyl ether, dibutyl ether, tetrahydrofuran, dioxane or cyclopentylmethyl ether; an ester solvent such as ethyl acetate, n-propyl acetate, isopropyl acetate, or n-butyl acetate; a ketone solvent such as acetone, methyl ethyl ketone, methyl-n-butyl ketone, or methyl isobutyl ketone; or the like.

In one embodiment, the first solvent may include a fast-drying solvent having a high drying rate and a slow-drying solvent having a relatively low drying rate. The slow-drying solvent may be a solvent having an evaporation rate, measured according to ASTM D 3539, of 0.8 or less. In one embodiment, the slow-drying solvent may include: a hydrocarbon solvent such as dodecane or undecane; an aromatic hydrocarbon solvent such as xylene or mesitylene; an alcohol solvent such as n-butanol, hexanol, 3-methyl-3-methoxybutanol, 3-methoxybutanol, methylcellosolve, ethylcellosolve, butyl cellosolve, methyl carbitol, ethyl carbitol, butyl carbitol, propylene glycol monomethyl ether, propylene glycol monoethyl ether, propylene glycol monopropyl ether, propylene glycol mono-n-butyl ether, propylene glycol mono-t-butyl ether, ethylene glycol mono-t-butyl ether, dipropylene glycol monomethyl ether, dipropylene glycol monoethyl ether, dipropylene glycol monopropyl ether, dipropylene glycol monobutyl ether and diacetone alcohol; an ether solvent such as diethylene glycol methyl ethyl ether, diethylene glycol dimethyl ether, diethylene glycol diethyl ether, dipropylene glycol dimethyl ether, diethylene glycol dibutyl ether, propylene glycol monomethyl ether acetate, propylene glycol monoethyl ether acetate, propylene glycol monopropyl ether acetate and dipropylene glycol monomethyl ether acetate; an ester solvent; a ketone solvent such as diisobutyl ketone, ethyl amyl ketone, 2-heptanone, 2-hexanone, 2-octanone, cyclopentanone and cyclohexanone; an amide solvent such as N,N-dimethylformamide and N,N-dimethylacetamide; or a lactone solvent such as γ-butyrolactone.

In one embodiment, the first solvent may include the fast-drying solvent and the slow-drying solvent at a weight ratio of 1:0.3 to 1:1.5. When the fast-drying solvent and the slow-drying solvent are present within the above weight ratio range, the ingredients of the color coating agent can be easily dispersed, and drying efficiency during thermal drying and appearance such as the smoothness of the prepared color coating layer can be excellent. Since the fast-drying solvent and the slow-drying solvent use the same ingredients as described above, a detailed description thereof will be omitted.

In one embodiment, the first solvent is present in an amount of 40 to 80% by weight based on the total weight of the color coating agent. When the first solvent is present in an amount of less than 40% by weight, dispersibility and miscibility are deteriorated, and when the first solvent is present in an amount exceeding 80% by weight, the drying time increases, resulting in poor workability, surface defects in the color coating layer, or deterioration in physical properties.

(4) Additives: In one embodiment, the color coating agent may further include additives. These components may be included to improve the workability, light resistance and smoothness of the color coating agent. The additives may include one or more of a leveling agent, a light stabilizer, an antifoaming agent and a wetting agent, but are not limited thereto. In one embodiment, the additives may be present in an amount of 0.01 to 10% by weight based on the total weight of the color coating agent. For example, the leveling agent may include a silicon-based leveling agent.

In one embodiment, the color coating layer may be formed by drying the applied color coating agent at 60 to 80° C. Under these conditions, the durability of the color coating agent can be excellent.

In one embodiment, the thickness of the color coating agent may be 1 to 30 μm. Within this thickness range, the adhesion and mechanical properties of the color coating layer can be excellent. For example, the thickness may be 15 to 20 μm.

### (S50) Forming Clear Layer

In this step, a clear coating agent is applied on the surface of the color coating layer, and is then photocured to form a clear layer.

In one embodiment, the clear coating agent may be applied and photocured to form a clear layer. The clear coating agent includes 10 to 30% by weight of a polyester-modified acrylic resin, 5 to 25% by weight of an acrylic oligomer, 5 to 45% by weight of an acrylic monomer, 1 to 15% by weight of a photoinitiator, and 10 to 75% by weight of a second solvent.

Hereinafter, the components of the clear coating agent will be described in more detail.

### Clear Coating Agent

(1) Polyester-modified acrylic resin: the polyester-modified acrylic resin may be included in order to improve the scratch resistance, chipping resistance, flexibility and interlayer adhesion of the clear layer.

In one embodiment, the polyester-modified acrylic resin may be prepared by polymerizing an unsaturated polybasic acid with a first reaction product, prepared through condensation between a polyhydric alcohol and a polybasic acid, to prepare a polyester precursor having a double bond at the end thereof and then polymerizing the polyester precursor with an acrylic monomer.

In one embodiment, the polyester-modified acrylic resin may have a weight average molecular weight of 5,000 to 50,000 g/mol, a hydroxyl value of 30 to 250 mgKOH/g, and a glass transition temperature of 40 to 90° C. Under the above conditions, the viscosity can be easily adjusted and thus workability can be excellent, and the chipping resistance, hardness, adhesion and scratch resistance of the clear layer can be superior.

In one embodiment, the polyester-modified acrylic resin may be present in an amount of 10 to 30% by weight based on the total weight of the clear coating agent. When the polyester-modified acrylic resin is present in an amount of less than 10% by weight, the chipping resistance, hardness, flexibility and adhesion of the clear layer may be deteriorated, and when the polyester-modified acrylic resin is present in an amount exceeding 30% by weight, the miscibility and dispersibility of the clear coating layer may be deteriorated.

(2) Acrylic oligomer: In one embodiment, the acrylic monomer may include an acrylate oligomer having two or more polymerizable functional groups. The acrylic oligomer may have a weight average molecular weight of 500 to 6,000 g/mol. Under the above conditions, the mechanical properties of the clear layer can be excellent.

In one embodiment, the acrylic oligomer is present in an amount of 5 to 25% by weight based on the total weight of the clear coating agent. When the acrylic oligomer is present in an amount less than 5% by weight, adhesion and photocuring efficiency may be deteriorated, and when the acrylic oligomer is present in an amount exceeding 25% by weight, the mechanical strength of the clear layer may be deteriorated.

(3) Acrylic monomer: In one embodiment, the acrylic monomer may include an acrylate monomer having two or more polymerizable functional groups.

In one embodiment, the acrylic monomer is present in an amount of 5 to 45% by weight based on the total weight of the clear coating agent. When the acrylic monomer is present in an amount less than 5% by weight, adhesion and photocuring efficiency may be deteriorated, and when the acrylic monomer is present in an amount exceeding 45% by weight, the mechanical strength of the clear layer may be deteriorated.

For example, the acrylic monomer and the acrylic oligomer may be present at a weight ratio of 1:2 to 1:4. Within the weight ratio defined above, miscibility, photocuring efficiency and workability can be excellent.

(4) Photoinitiator: the photoinitiator may be included to form a clear layer by photocuring the clear coating agent. In one embodiment, the photoinitiator may include one or more of 2-hydroxy-2-methyl-1-phenylpropane-1-phenone, 1-hydroxycyclohexylphenylketone, benzophenone, 1-(4-isopropylphenyl) 2-hydroxy 2-methyl 1-one, 1-[4-(2-hydroxyethoxy)phenyl]-2-hydroxy-2-methyl propane-1-one, α,α-diethoxyacetophenone, 2,2-diethoxy 1-phenylethanone and bis(2,4,6-trimethyl benzoyl)-phenylphosphine oxide.

In one embodiment, the photoinitiator is present in an amount of 1 to 15% by weight based on the total weight of the clear coating agent. When the photoinitiator is present in an amount of less than 1% by weight, photocuring does not proceed easily, and when the photoinitiator is present in an amount exceeding 15% by weight, workability and the mechanical properties of the clear layer may be deteriorated.

(5) Second solvent: The second solvent makes it easy to adjust the viscosity of the clear coating agent and improves the smoothness of the clear layer and workability during photocuring.

In one embodiment, the second solvent may include a fast-drying solvent and a slow-drying solvent at a weight ratio of 1:0.8 to 1:2. When the fast-drying solvent and the slow-drying solvent are present within the above weight ratio range, the ingredients of the clear coating agent can be easily dispersed, and drying efficiency during photocuring and the appearance of the prepared clear layer, such as the smoothness thereof, can be excellent. Since the fast-drying solvent and the slow-drying solvent use the same ingredients as described above, a detailed description thereof will be omitted.

In one embodiment, the second solvent is present in an amount of 10 to 75% by weight based on the total weight of the clear coating agent. When the second solvent is present in an amount less than 10% by weight, dispersibility and miscibility are deteriorated, and when the second solvent is present in an amount exceeding 75% by weight, the drying time increases, resulting in poor workability, surface defects in the clear layer, or deterioration in physical properties.

In one embodiment, the clear coating agent may include at least one of 0.1 to 5% by weight of a light stabilizer, 0.1 to 5% by weight of a heat stabilizer, 0.1 to 5% by weight of an adhesion promoter, and 0.1 to 10% by weight of an additive based on the total weight of the clear coating agent.

(6) Light stabilizer: The light stabilizer may be included to prevent surface defects in the clear layer and improve light stability and weather resistance. For example, the light stabilizer may include one or more of a triazine ultraviolet light stabilizer and a hindered amine light stabilizer (HALS).

In one embodiment, the triazine UV absorber includes 6-bis (2,4-dimethylphenyl)]-1,3,5-triazine, 6-bis(2,4-dimethylphenyl)-1,3,5 triazine and tris2,4,6-[2-4-(octyl-2-methylethanoate)oxy-2-hydroxyphenyl]-1,3,5 triazine or the like. These may be used alone or in combinations of two or more, but the present disclosure is not limited thereto.

In one embodiment, the hindered amine UV stabilizer may be 2,2,6,6-tetramethyl-4-piperidyl stearate, 1,2,2,6,6-pentamethyl-4-piperidyl benzoate, N-(2,2,6,6-tetramethyl-4-piperidyl) dodecyl succinimide, 1-[(3,5-di-t-butyl-4-hydroxyphenyl)propionyloxyethyl]-2,2,6,6-tetramethyl-4-piperidyl-(3,5-di-t-butyl-4-hydroxyphenyl)propionate, bis(2,2,6,6-tetramethyl-4-piperidyl) sebacate, bis(1,2,2,6,6-pentamethyl-4-piperidyl)sebacate, bis(1,2,2,6,6-pentamethyl-4-piperidyl)-2-butyl-2-(3,5-di-t-butyl-4-hydroxybenzyl)malonate, N, N′-bis(2,2,6,6-tetramethyl-4-piperidyl)hexamethylenediamine, tetra (2,2,6,6-tetramethyl-4-piperidyl) butanetetracarboxylate, tetra(1,2,2,6,6-pentamethyl-4-piperidyl) butanetetracarboxylate and bis (2,2,6,6-tetramethyl-4-piperidyl)⋅di(tridecyl)butanetetracarboxylate or the like. These may be used alone or in combinations of two or more, but the present disclosure is not limited thereto.

The light stabilizer may be present in an amount of 0.1 to 5% by weight based on the total weight of the clear coating agent. When the light stabilizer is present in an amount within the above range, surface defects of the clear layer can be prevented, and weather resistance and an anti-yellowing effect can be excellent.

(7) Heat stabilizer: The heat stabilizer may include a phenol-based, phosphite-based or lactone-based heat stabilizer or the like. In one embodiment, the heat stabilizer may be present in an amount of 0.1 to 5% by weight based on the total weight of the clear coating agent. When the heat stabilizer is present in an amount within this range, thermal stability can be excellent and deterioration in mechanical properties of the clear layer can be prevented.

(8) Adhesion promoter: The adhesion promoter may include an ether adhesion promoter. In one embodiment, the adhesion promoter may be present in an amount of 0.1 to 5% by weight based on the total weight of the clear coating agent. When the adhesion promoter is present in an amount within the above range, interlayer adhesion can be excellent, and deterioration in mechanical properties of the clear layer can be prevented.

(9) Additive: The additive may include, but is not limited to, one or more of a leveling agent, an antifoaming agent and a wetting agent. In one embodiment, the additive may be present in an amount of 0.01 to 10% by weight based on the total weight of the clear coating agent. For example, the leveling agent may include a silicon-based leveling agent.

In one embodiment, the thickness of the clear layer may be 10 to 50 μm. Within the thickness range, the adhesion of the clear layer can be excellent, and mechanical properties such as weather resistance and chipping resistance can be excellent. For example, the thickness of the clear layer may be 20 to 30 μm.

In one embodiment, the sum of the thickness of the color coating layer and the clear layer may be 15 to 90 μm. Under the above condition, the appearance can be excellent, and mechanical properties such as weather resistance and chipping resistance can be excellent. For example, the sum of the thickness may be 45 to 85 μm.

In one embodiment, the color coating layer and the clear layer may be formed at a thickness ratio of 1:1.2 to 1:3. Within this thickness ratio range, both appearance and chipping resistance can be excellent.

In addition, there is no particular limitation as to the method of applying the color coating agent and the clear coating agent. For example, brushing, spray coating, dip coating, spin coating and the like, all of which are widely used in the art, may be used, but the present disclosure is not limited thereto.

### Multiple-Color Plating Member Manufactured by Method of Manufacturing Multiple-Color Plating Member

Another aspect of the present disclosure relates to a multiple-color plating member manufactured by the method of forming a multiple-color plating member.

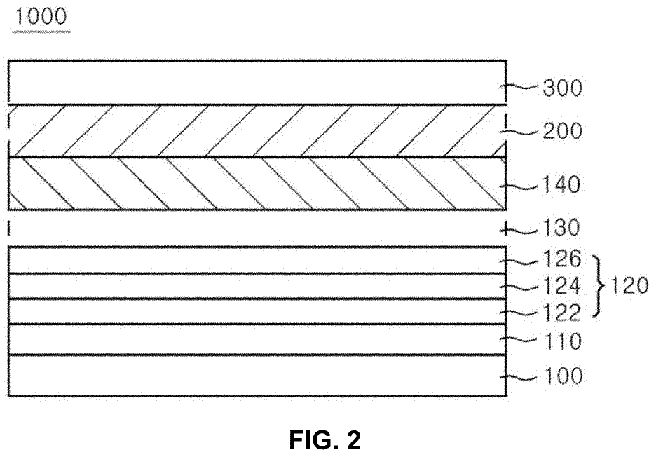

FIG. 2 shows a multiple-color plating member according to one embodiment of the present disclosure. Referring to FIG. 2, the multiple-color plating member 1000 includes a substrate 100, a copper plating layer 110 formed on at least a part of a surface of the substrate 100, a nickel plating layer 120 formed on a surface of the copper plating layer 110, a chromium plating layer 130 formed on the surface of the nickel plating layer 120, a color coating layer 200 formed on the surface of the chromium plating layer 130 and a clear layer 300 formed on the surface of the color coating layer 200.

In one embodiment, the nickel plating layer 120 may include a first nickel plating layer 122, a second nickel plating layer 124 and a microporous (MP) nickel plating layer 126, which are sequentially stacked.

In one embodiment, the color coating layer is formed using a color coating agent containing 10 to 35% by weight of a modified acrylic resin, 1 to 25% by weight of a pigment and 40 to 80% by weight of a first solvent, wherein the clear coating layer is formed using a clear coating agent containing 10 to 30% by weight of a polyester-modified acrylic resin, 5 to 25% by weight of an acrylic oligomer, 5 to 45% by weight of an acrylic monomer, 1 to 15% by weight of a photoinitiator and 10 to 75% by weight of a second solvent.

Since the ingredients and the contents constituting the color coating agent and the clear coating agent are the same as described above, a detailed description thereof will be omitted.

In one embodiment, the thickness of the copper plating layer may be 5 to 30 μm. Within this thickness range, adhesion with the substrate, durability and impact resistance can be excellent.

In one embodiment, the thickness of the nickel plating layer may be 5 to 50 μm. Within this thickness range, adhesion, durability and impact resistance can be excellent.

In one embodiment, the thickness of the chromium plating layer may be 5 to 20 μm. Within this thickness range, durability, abrasion resistance and the appearance of the chromium plating layer can be excellent.

In one embodiment, the thickness of the color coating layer may be 10 to 30 μm. Within this thickness range, chipping resistance, adhesion and the appearance of the color coating layer can be excellent. For example, the thickness may be 15 to 20 μm.

In one embodiment, the thickness of the clear layer may be 10 to 50 μm. Within this thickness range, the adhesion of the clear layer can be excellent, and mechanical properties such as weather resistance and chipping resistance can be excellent. For example, the thickness may be 20 to 30 μm.

In one embodiment, the sum of the thickness of the color coating layer and the clear layer may be 15 to 90 μm. Under the above conditions, appearance as well as mechanical properties such as weather resistance and chipping resistance can be excellent. For example, the sum of the thickness may be 45 to 85 μm.

In one embodiment, the color coating layer and the clear layer may be formed at a thickness ratio of 1:1.2 to 1:3. Within this thickness ratio range, both appearance and chipping resistance can be excellent.

In one embodiment, the multiple-color plating member may be used as an exterior part for vehicles, for example, a vehicle radiator grille, but the present disclosure is not limited thereto.

The multiple-color plating member manufactured by the method of manufacturing a multiple-color plating member according to the present disclosure is highly lightweight, and has excellent appearance such as glossiness, excellent chipping resistance, scratching resistance, excellent durability, chemical resistance and weather resistance, light resistance and excellent adhesion between coating layers.

Hereinafter, the configurations and operations of the present disclosure will be described in more detail with reference to preferred embodiments of the present disclosure. However, these embodiments are provided as preferred examples of the present disclosure, and should not be construed as limiting the present disclosure by any means. Technical details not described herein can be sufficiently conceived by those skilled in the art and thus will be omitted.

### EXAMPLES AND COMPARATIVE EXAMPLES

(a) Formation of plating layer: electroplating was performed on the surface of a substrate (ABS material) using a copper plating solution to form a copper plating layer having a thickness of 5 to 10 μm. Electroplating was performed on the surface of the copper plating layer using a first nickel plating solution to form a semi-gloss first nickel plating layer, electroplating was performed on the surface of the first nickel plating layer using a second nickel plating solution to form a glossy second nickel plating layer, and electroplating was performed on the surface of the second nickel plating layer using a MP nickel plating solution to form a MP nickel plating layer. At this time, the total thickness of the nickel plating layer was formed to 10 to 25 μm. Then, a chromium plating layer having a thickness of 5 to 30 μm was formed on the surface of the substrate provided with the MP nickel plating layer using a chromium plating solution.

(2) Formation of color coating layer: a color coating agent containing 10 to 35% by weight of a modified acrylic resin, 1 to 25% by weight of a pigment (including a violet pigment and a red pigment), 40 to 80% by weight of a first solvent and 0.1 to 5% by weight of an additive (leveling agent) was prepared.

The color coating agent was applied onto the surface of the plating layer and was then thermally dried at 60 to 80° C. to prepare a color coating layer having a thickness of 30.3 μm.

(3) Formation of clear layer: a clear-layer agent containing 10 to 30% by weight of a polyester-modified acrylic resin, 5 to 25% by weight of an acrylic oligomer, 5 to 45% by weight of an acrylic monomer, 1 to 15% by weight of a photoinitiator, 10 to 75% by weight of a second solvent, 0.1 to 5% by weight of a light stabilizer, 0.1 to 5% by weight of a heat stabilizer, 0.1 to 5% by weight of an adhesion promoter and 0.1 to 10% by weight of an additive (leveling agent) was prepared.

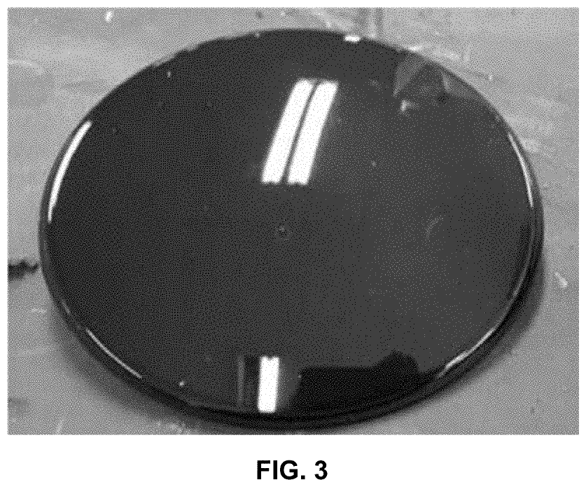

The clear coating agent was applied onto the surface of the color coating layer, and was then photocured by irradiation with ultraviolet light at a dose of 800 to 2,000 mJ/cm² to form a clear layer having a thickness of 51.3 μm and thereby to prepare a multiple-color plating member as shown in FIG. 3.

### Physical Property Evaluation Test

The physical properties of the specimen according to Example were evaluated based on the Hyundai-Kia Motors MS655-14 standard as shown in Table 1 below, and the results are shown in Table 2 below.

TABLE 1

| Test item | Test method and standard (MS655-14) |
|---|---|
| Pencil hardness | HB or higher |
| Adhesive force | M-1~M-2.5 |
| Impact resistance | Coating film has fine cracks, but should not |
| | be detached. |
| | (4-score evaluation - Very good: ●, good: ∘, |
| | moderate: ▴, bad: x) |
| Water resistance | Coating films should have no discoloration, |
| Saline resistance | bleaching, swelling, cracks, gloss deterioration |
| Acid resistance | or the like, and should have adhesive force of |
| Alkali resistance | M-1 to M-2.5. |
| | (4-score evaluation - Very good: ●, good: ∘, |
| | moderate: ▴, bad: x) |
| Oil resistance | Coating films should have no swelling, cracks, |
| Chemical resistance | adherend exposure or the like. |
| Fuel oil resistance | (4-score evaluation - Very good: ●, good: ∘, |
| Wax resistance | moderate: ▴, bad: x) |
| Gasoline resistance | |
| Heat resistance | Coating films should have no swelling, cracks |
| cycle | gloss deterioration or the like, and should |
| | have adhesive force of M-1 to M-2.5. |
| High-pressure car | After the test, coating films should have a |
| cleaning resistance | detachment size of less than 2 mm (one scale) |
| | and have no problems such as swelling or cracks. |
| | (4-score evaluation - Very good: ●, good: ∘, |
| | moderate: ▴, bad: x) |
| Weather resistance | Coating films should have no discoloration, |
| | bleaching, swelling, cracks, gloss deterioration |
| | or the like and have adhesive force of M-1 to M-2.5. |
| | (4-score evaluation - Very good: ●, good: ∘, |
| | moderate: ▴, bad: x) |
| Chipping resistance | After tests of three specimens, two or more |
| | specimens should satisfy the following |
| | conditions: scratches having a chipping size |
| | of 1 mm or more should be 3 or fewer in number. |
| | In this case, scratches having a chipping size |
| | of less than 1 mm or scratches wherein an |
| | adherend is not exposed will be excluded from |
| | evaluation |
| | (4-score evaluation - Very good: ●, good: ∘, |
| | moderate: ▴, bad: x) |

TABLE 2

| Test item | Example |
|---|---|
| Pencil hardness | OK (2H or more) |
| Adhesive force | OK (M2.5) |
| Impact resistance | ● |
| Water resistance | OK (M2.0) |
| Saline resistance | OK (M2.5) |
| Acid resistance | ● |
| Alkali resistance | ● |
| Oil resistance | ● |
| Chemical resistance | ● |
| Fuel oil resistance | ● |
| Wax resistance | ● |
| Gasoline resistance | ● |
| Heat resistance cycle | OK (M2.3) |
| High-pressure car cleaning | ● |
| Weather resistance | ● |
| Chipping resistance | ● |

As can be seen from the results of Table 2, the multiple-color plating member according to the present disclosure has excellent appearance, chipping resistance, scratching resistance, durability, chemical resistance and weather resistance and is highly lightweight, and thus can efficiently replace conventional metal parts, and exhibits excellent light resistance and adhesive force between the coating layer and the coating layer.

As apparent from the foregoing, the multiple-color plating member manufactured by the method of manufacturing a multiple-color plating member according to the present disclosure is highly lightweight and exhibits excellent appearance such as glossiness, chipping resistance, scratch resistance, durability, appearance, chemical resistance, weather resistance, light resistance and adhesive force between the coating layers.

The effects of the present disclosure are not limited to those mentioned above. It should be understood that the effects of the present disclosure include all effects that can be inferred from the foregoing description of the present disclosure.

The present disclosure has been described in detail with reference to preferred embodiments thereof. However, it will be appreciated by those skilled in the art that changes may be made in these embodiments without departing from the principles and spirit of the present disclosure, the scope of which is defined in the appended claims and their equivalents.

1. A method of manufacturing a multiple-color plating member comprising:
forming a copper plating layer on at least a part of a surface of a substrate;
forming a nickel plating layer on a surface of the copper plating layer;
forming a chromium plating layer on a surface of the nickel plating layer;
applying a color coating agent onto a surface of the chromium plating layer and then drying the applied color coating agent to form a color coating layer; and
applying a clear coating agent onto a surface of the color coating layer and photocuring the applied clear coating agent to form a clear layer,
wherein the color coating agent comprises:
10 to 35% by weight of a modified acrylic resin;
1 to 25% by weight of a pigment; and
40 to 80% by weight of a first solvent, and
wherein the clear coating agent comprises:
10 to 30% by weight of a polyester-modified acrylic resin;
5 to 25% by weight of an acrylic oligomer;
5 to 45% by weight of an acrylic monomer;
1 to 15% by weight of a photoinitiator; and
10 to 75% by weight of a second solvent.

2. The method according to claim 1, wherein the forming of the nickel plating layer comprises:
forming a semi-gloss first nickel plating layer on a surface of the copper plating layer;
forming a glossy second nickel plating layer on a surface of the first nickel plating layer; and
forming a microporous (MP) nickel plating layer on a surface of the second nickel plating layer.

3. The method according to claim 1, wherein the copper plating layer has a thickness of 5 to 30 μm, the nickel plating layer has a thickness of 5 to 50 μm, and the chromium plating layer has a thickness of 5 to 20 μm.

4. The method according to claim 1, wherein the color coating layer is formed by drying the applied color coating agent at 60 to 100° C.

5. The method according to claim 1, wherein each of the first solvent and the second solvent comprises a fast-drying solvent and a slow-drying solvent at a weight ratio of 1:0.3 to 1:1.5.

6. The method according to claim 1, wherein the color coating layer has a thickness of 10 to 30 μm, and the clear layer has a thickness of 10 to 50 μm.

7. A multiple-color plating member comprising:
a substrate;
a copper plating layer formed on at least a part of a surface of the substrate;
a nickel plating layer formed on a surface of the copper plating layer;
a chromium plating layer formed on a surface of the nickel plating layer;
a color coating layer formed on a surface of the chromium plating layer; and
a clear layer formed on a surface of the color coating layer,
wherein the color coating layer is formed using a color coating agent comprising 10 to 35% by weight of a modified acrylic resin, 1 to 25% by weight of a pigment and 40 to 80% by weight of a first solvent, and
wherein the clear coating layer is formed using a clear coating agent comprising 10 to 30% by weight of a polyester-modified acrylic resin, 5 to 25% by weight of an acrylic oligomer, 5 to 45% by weight of an acrylic monomer, 1 to 15% by weight of a photoinitiator and 10 to 75% by weight of a second solvent.

8. The multiple-color plating member according to claim 7, wherein the color coating layer and the clear layer are formed at a thickness ratio of 1:1.2 to 1:3.
